(19) United States
(12) Patent Application Publication
(10) Pub. No.: US 2017/0006833 A1
(43) Pub. Date: Jan. 12, 2017

(54) DOG CONTROL DEVICE

(71) Applicant: James Brogan, Huntington Station, NY (US)

(72) Inventor: James Brogan, Huntington Station, NY (US)

(21) Appl. No.: 14/794,704

(22) Filed: Jul. 8, 2015

(51) Int. Cl. A01K 15/04; A01K 15/02; A01K 3/00

(52) U.S. Cl. CPC A01K 15/04; A01K 3/00; A01K 15/02

(57) ABSTRACT

A dog control device for blocking a dog's movement to keep the dog in the heel position while effectively conditioning and training the dog's movement. The dog restraining device includes a discrete control member that defines an elongated angled pole having a upper section and a lower section telescopically integrated with the upper section. The upper section includes a handle that allows a user to hold the control member and the lower section includes a crescent shaped distal end that is angled to extend horizontally away from one who is holding the handle in front of a dog that they are walking Accordingly, the distal end provides a barrier that can prevent a dog from walking past its handler.

### BACKGROUND OF THE INVENTION

1. Field of the Invention

This invention relates generally to animal control device and, more particularly, to an dog conditioning and training device for use with a conventional leash to non-invasively prevent the dog from passing the user.

2. Description of the Prior Art

It is well known that as a part of conventional dog training, a dog is taught to heel, or stay behind or at the heels, when walking with their owner or caretaker. As time passes, however, it is common for the owner/caretaker, the dog, or both to become more lax with this heel technique. While conventional dog restraining apparatus, such as leashes, are commonly employed in attempt to control a dog's movement, such apparatus are not particularly effective at maintaining a dog in a heel position without constantly pulling and yanking at a dog's neck. Consequently, a problem which still exists is that conventional animal control devices are generally unable to maintain a dog in a heel position. Thus, there remains a need for a dog control device which included a control member that allows an owner/caretaker of a dog to effortlessly maintain the dog in the heel position while walking It would be helpful if such a dog control device was able to be used with a conventional leash to supplement a structural barrier that conditions and trains the dog. It would be additionally desirable for the control member of such a dog control device to be adjustable telescopically so as to be used by owners/caretakers of different heights and dogs of different sizes.

The Applicant's invention described herein provides for a dog control device adapted to allow a user to place a barrier in front of a dog to keep the animal in the heel position while walking The primary components in Applicant's dog control device are a lower blocking section and an upper handling section. When in operation, the dog control device enables an owner/caretaker to provide a constant reminder to a dog to remain in the heel position while walking As a result, many of the limitations imposed by prior art structures are removed.

### SUMMARY OF THE INVENTION

A dog control device for blocking a dog's movement to keep the dog in the heel position while effectively conditioning and training the dog's movement. The dog control device comprises a discrete control member that defines an elongated angled pole having a upper section and a lower section telescopically integrated with the upper section. The upper section includes a handle that allows a user to hold the control member and the lower section includes a crescent shaped distal end that is angled to extend horizontally away from one who is holding the handle (a “handler,” who may be an owner or other caretaker) in front of a dog that they are walking. Accordingly, the distal end provides a barrier that can prevent a dog from walking past its handler.

It is an object of this invention to provide a dog control device which included a control member that allows handler of a dog to effortlessly maintain the dog in the heel position while walking.

It is another object of this invention to provide a dog control device that which is able to be used with a conventional leash to supplement a structural barrier that conditions and trains the dog.

It is yet another object of this invention to provide a dog control device with a control member that can be adjustable telescopically so as to be used by handlers of different heights and dogs of different sizes.

These and other objects will be apparent to one of skill in the art.

### BRIEF DESCRIPTION OF THE DRAWINGS

FIG. 1 is an elevational view of a dog control device built in accordance with the present invention in a short configuration.

FIG. 2 is a perspective view of a dog control device built in accordance with the present invention in an extended configuration in place on a dog and handler.

### DETAILED DESCRIPTION OF THE INVENTION

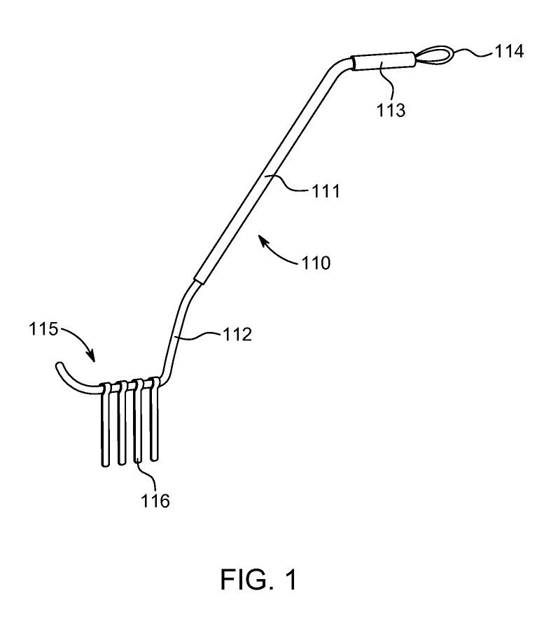

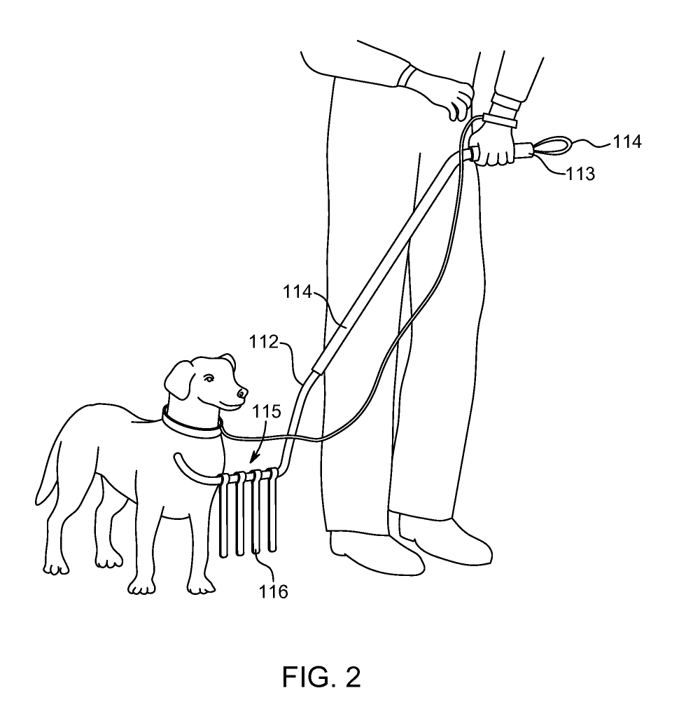

Referring now to the drawings and in particular FIGS. 1 and 2, a dog control device 100 is shown as a discrete control member 110 which define an elongated angled pole having a upper section 111 and a lower section 112 telescopically integrated with the upper section 111 so as to allow the lower section 112 to move between a short configuration, as illustrated by FIG. 1, and an extended configuration, as illustrated by FIG. 2. At the end of the upper section 111 opposite lower section 112 is a handle 113 for allowing a handler to hold the control member 110 and a hanging loop 114 for allowing the control member 110 to be hung on a hook when not in use.

The lower section 112 is defined by a crescent shaped distal end 115 that is angled to extend horizontally away from the handler that is holding the handle 113 in front of a dog that they are walking. In one embodiment, the lower section 112 includes a plurality of reflective streamers 116 attached to it which extend vertically down from the distal end 115. It is contemplated that the reflective streamers may be removably attached to the distal end 115 through a hook and loop fastener system.

In the preferred embodiment, the upper section 111 and lower section 112 are constructed of a rigid material, such as plastic or aluminum In some embodiments, the distal end 115 is covered with a padded material. In some embodiments, the distal end is coated with a reflective substance.

It is contemplated that the dog control device 100 may be deployed with a conventional dog leash or harness. In some embodiments, the hanging loop 114 may be employed to hold such a leash or harness.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A dog control device, comprising a discrete control member defining an elongated, angled pole having a upper section and a lower section, wherein said lower section has a distal end oriented to extend horizontally so as to form a barrier operative to block the movement of a dog.

2. The dog control device of claim 1, wherein said lower section is telescopically integrated with said lower section so as to allow the lower section to move between a short configuration and an extended configuration.

3. The dog control device of claim 1, wherein said lower section is defined by a crescent shaped distal end.

4. The dog control device of claim 3, additionally comprising a plurality of streamers attached to said lower section such that they extend vertically down from the distal end.

5. The dog control device of claim 1, wherein said upper section includes a handle and a hanging loop.
